(19) United States
(12) Patent Application Publication
(10) Pub. No.: US 2009/0280458 A1
(43) Pub. Date: Nov. 12, 2009

(54) Combination teaching and learning kit and method

(76) Inventor: Janet R. Myers, Lochmere, NH (US)

Correspondence Address: JAMES RAY & ASSOCIATES, 2640 PITCAIRN ROAD, MONROEVILLE, PA, 15146, US

(21) Appl. No.: 12/152,002

(22) Filed: May 12, 2008

(51) Int. Cl. G09B 19/00; G09B 11/04; G09B 19/22

(52) U.S. Cl. 434/167; 434/163; 434/170; 434/172

(57) ABSTRACT

A combination teaching and learning kit is provided. Such combination teaching and learning kit includes a chart member for at least one of free standing and attachment to a wall, a table, and an item of furniture. A plurality of card members having predetermined indicia disposed on at least first predetermined side thereof and a securing mechanism disposed on at least an opposite second predetermined side thereof for releasably attaching the card members to such chart member.

### FIELD OF THE INVENTION

The present invention relates, in general, to learning devices and methods, more particularly, this invention relates to learning devices and methods for teaching people, especially children, how to read, write, and spell.

### BACKGROUND OF THE INVENTION

Prior to the conception and development of the present invention, reading, writing, and spelling, as are generally well known in the prior art, are taught to children as part of their schooling and may also be taught to adult students who lack those skills. Unfortunately, a large number of students have a difficult time learning to read, write and spell. Typical teaching methods include introducing the letters of the alphabet by name and presenting visual letter representations in fancy illegible script. Furthermore such teaching methods often use examples that are beyond a beginner's level of skill and are confusing overall. Therefore, there exists a need for a teaching and learning apparatus and method which eliminates confusion and presents information in a simple concise form which is understandable by children and adults who are learning to read, write, and spell.

Specifically of interest to the present invention are the following: Mejia, U.S. Pat. No. 7,011,525 discloses a system and method for literacy and language instruction that can be practiced with graphophonic word-building blocks, learning activities, software, an electronic device, and educational card/dice/bingo, etc. games with multi-sensory learning that revolves around and ideally combines graphophonic, semantic, and syntactic activity in language/literacy development. A chart contains 44 images that represent the 44 sounds of English. Each image can be used as a phoneme cue (Phoneme Cue Image) for both phonemic awareness, phonological activity, and encoding words that may have a proximate display of alternate spellings around the Phoneme Cue Image on the block or card.

Robotham, U.S. Pat. No. 6,966,777, discloses a book-like reading teaching tool having a plurality of columns wherein each column contains each letter of the alphabet in ascending format, a picture corresponding to each sound of each letter in the alphabet and structure for interchanging, mixing and matching letters and identifying and selecting long vowel and short vowel sounds. The reading tool includes a front cover, back cover, spiral binder, instructions, alphabet indicia, plurality of pictures corresponding to each letter and sound in the alphabet, plurality of windows or cutouts corresponding to selected letters and sounds, short vowel sound indicia, long vowel sound indicia and plurality of flip panels arranged in columns wherein each panel in each column contains a letter indicia. The covers, pages and panels have a plurality of apertures that are joined at coinciding ends by the spiral binder.

Rai, U.S. Pat. No. 6,077,080, discloses an education method. The method is designed for being able to teach and to learn reading with the proper sounding of the English alphabet. It employs colors and symbols to represent 18 vowel sounds, 30 consonant, phonogram sounds and silent sounds. Each colored alphabet letter maps a designated sound which helps to depict a correct sounding from various spelled combinations of the English language. This color and symbol mapping method is meant to teach reading of the English words as well as to spell correctly.

Hengel, U.S. Pat. No. 4,345,902 discloses an educational device for aiding in the teaching of the mechanics of reading which employs color coded cards using three colors to facilitate teaching and learning the alphabet, the sounds the alphabet letters represent, subsequent word attack skills and necessary sight words.

### SUMMARY OF THE INVENTION

The present invention provides a combination teaching and learning kit. Such teaching and learning kit includes a chart member for at least one of free standing and attachment to a wall, a table, and an item of furniture. Such kit further includes a plurality of card members having predetermined indicia disposed on at least a first predetermined side thereof and a securing means disposed on at least an opposite second predetermined side thereof for releasably attaching such card members to the chart member.

According to another embodiment, a method of teaching an individual to at least one of read, write, and spell is provided. Such method includes providing a chart member for at least one of free standing and attachment to a wall, a table, and an item of furniture. Providing a plurality of card members each having at least one of a predetermined letter of a predetermined alphabet and a predetermined picture disposed on at least a first predetermined side thereof and a securing means disposed on at least a second predetermined side thereof for releasably attaching such card members to such chart member. Instructing such individual to trace a predetermined object over a predetermined portion of a predetermined card member. Instructing such individual to repeat a predetermined sound while at least one of viewing such predetermined card member and tracing over such predetermined portion of such predetermined card member.

### OBJECTS OF THE INVENTION

It is, therefore, one of the primary objects of the present invention to provide a teaching and learning kit and method for teaching young children to learn to read, write and spell easily.

Another object of the present invention is to provide a teaching and learning kit and method which incorporates multiple components for use in teaching and learning to read, write, and spell.

Still another object of the present invention is to provide a method which emphasizes the sound that each letter of the alphabet represents rather than the names of the letters.

Yet another object of the present invention is to provide a teaching and learning kit which includes at least one of a phonics chart, a bingo game, tracing worksheets, instructions for teaching, a lesson plan for introducing each letter of the alphabet, a phonics song, cue cards, word cards, letter cards, picture cards, phonetically sequenced reading books, an instructional website, and a combination thereof.

An additional object of the present invention is to provide a portable teaching and learning kit for use in teaching a person to read, write and spell and for use by a person learning how to read, write, and spell.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention in which a chart member has a plurality of card members attached thereto.

FIG. 2 is a partial perspective view of the invention according to one embodiment of the invention in which a chart member has a plurality of card members attached thereto and a plurality of such card members have been removed therefrom.

FIG. 3 is a partial perspective view of the invention according to one embodiment of the invention in which a card member includes indicia thereon depicting a letter of an alphabet and a corresponding picture, such picture being describable by a word which is spelled having a first letter being the same as such letter depicted on such card member.

FIG. 4 is a partial perspective view of the invention according to one embodiment of the invention in which a card member includes a securing means disposed on a predetermined side thereon.

FIG. 5 is a partial perspective view of the invention according to one embodiment of the invention in which such kit includes a phonics bingo game.

FIG. 6 is a partial perspective view of the invention according to one embodiment of the invention in which such kit includes tracing worksheets.

FIG. 7 is a partial perspective view of the invention according to one embodiment of the invention in which such kit includes teaching instructions and a lesson plan disposed on a fixed media.

FIG. 8 is a partial perspective view of the invention according to one embodiment of the invention in which such kit includes a plurality of label members each of which includes predetermined indicia disposed thereon for describing a corresponding picture on each of such card members.

FIG. 9 is a partial perspective view of the invention according to one embodiment of the invention in which such kit further includes a predetermined phonics related song disposed at least one of on and within a fixed media.

FIG. 10 is a partial perspective view of the invention according to one embodiment of the invention in which additional card members are included in such kit such that at least one predetermined card member and at least one additional card member may be aligned to spell at least one word.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

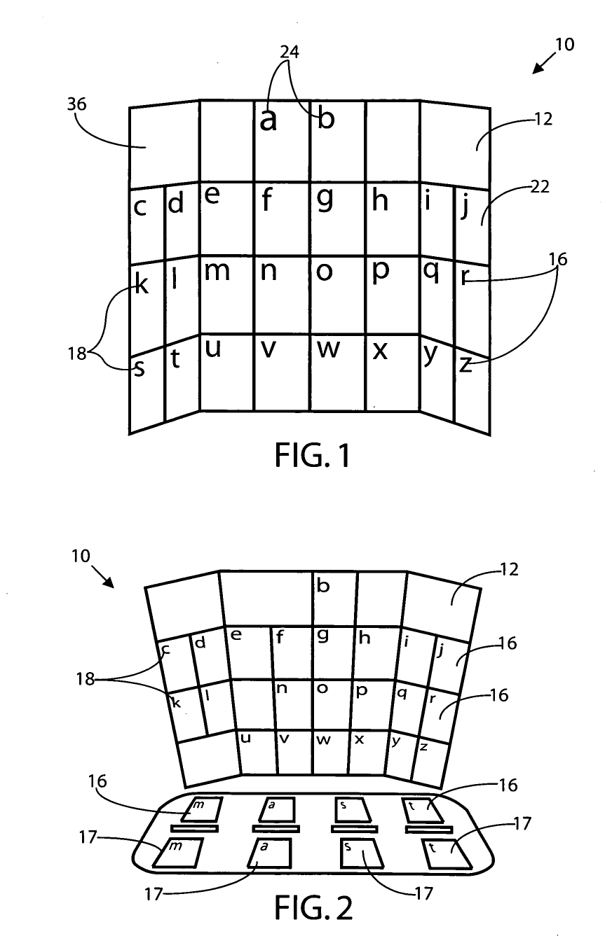

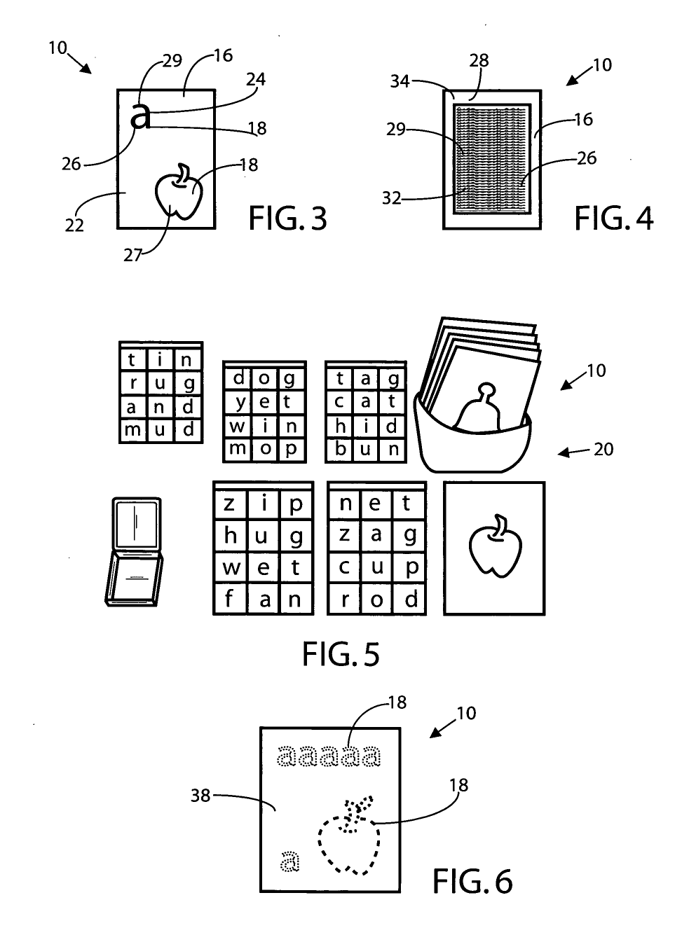

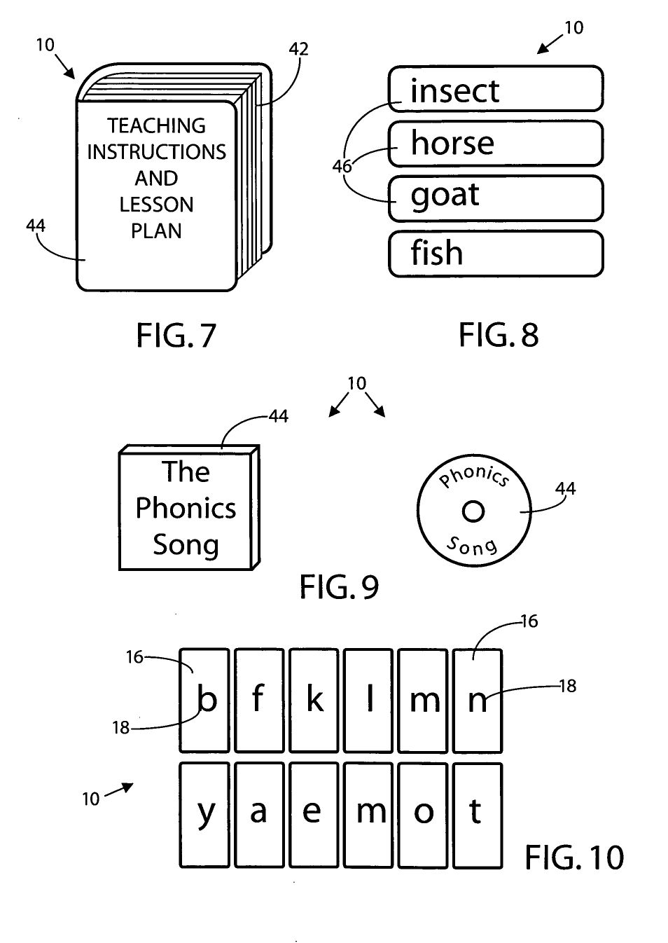

Reference is now made, more particularly, to FIGS. 1-10.

A combination teaching and learning kit, generally designated 10, is provided. Such combination teaching and learning kit 10 includes a chart member 12 for at least one of free standing and attachment to a wall, a table, and an item of furniture.

It is presently preferred that such chart member 12 is foldable such that such chart member 12 may be folded at least in half. It is presently most preferred that such chart member 12 may be folded in thirds.

Such kit 10 further includes a plurality of card members 16 having predetermined indicia 18 disposed on at least a first predetermined side 22 thereof.

It is presently preferred that such card members 16 are color coded according to predetermined features of such indicia 18.

It is further presently preferred that such indicia 18 on such card members 16 is color coded according to predetermined features of the indicia 18.

It is presently preferred that such indicia 18 includes at least one predetermined letter 24 of a predetermined alphabet and a predetermined picture 27 of at least one of a person, an animal and a thing being describable by a word which is spelled having a first letter substantially identical to such predetermined letter.

It is presently preferred that such predetermined alphabet letters 24 are color coded according to whether the letters 24 are consonants or vowels.

It is presently preferred that such card members 16 are laminated.

A securing means 26 is disposed on at least an opposite second predetermined side 28 of such card members for releasably attaching such card members 16 to such chart member 12.

It is presently preferred that such securing means 26 is at least one of an adhesive, a hook and loop, and a snap type securing means.

It is presently preferred that such securing means 26 is shaped in a form of such predetermined indicia 18 and is disposed on each of such first predetermined side 22 and an opposite second predetermined side 28 of such card members 16.

It is further presently preferred that such securing means 26 is a hook and loop type securing means 29 and wherein the hook and loop type securing means 29 has a first portion 32 thereof disposed on at least one predetermined side 34 of such card members 16 and wherein a second portion 36 of the hook and loop type securing means 29 is disposed on a predetermined location of such chart member 16 such that the first portion 32 and the second portion 36 may be joined thereby releasably securing such card members 16 to such chart member 12.

It is presently preferred that such combination teaching and learning kit 10 further includes a phonics bingo game, generally designated 20.

It is presently preferred that such combination teaching and learning kit 10 further includes tracing worksheets 38 having predetermined indicia 18 depicted thereon such that a user may trace over the indicia 18 to reveal at least one of a predetermined alphabet letter, a symbol, a picture, and a combination thereof.

It is further presently preferred that such combination teaching and learning kit 10 further includes predetermined teaching instructions 42 disposed on a fixed media 44. It is presently preferred that such fixed media 44 is at least one of a computer processing unit, a CD, a book, a booklet, a pamphlet, a DVD, an audio cassette, and a video cassette.

It is presently preferred that such teaching instructions include a lesson plan for planning at least fifteen lessons. It is further presently preferred that a first lesson focuses on the letters “m”, “a”, “s”, and “t”, a second lesson focuses on the letters “c”, “r”, “i”, and “b”, a third lesson focuses on the letters “p”, “e”, “n”, and “d”, a fourth lesson focuses on the letters “g”, “o”, “l”, and “f”, a fifth lesson focuses on the letters “a”, “e”, “i”, “o” and “u”, a sixth lesson focuses on the letters “b”, “d”, “p”, and “q”, a seventh lesson focuses on the letters “a”, “c”, “d”, “e”, “g”, “o”, and “q”, an eighth lesson focuses on the letters “b”, “f”, “h”, “k”, “l”, and “t”, a ninth lesson focuses on the letters “g”, “j”, “p”, “q”, “y”, “v”, “w”, “x”, and “z”, a tenth lesson focuses on blending words with the letter “a”, an eleventh lesson focuses on blending words with the letter “i”, a twelfth lesson focuses on blending words with the letter “e”, a thirteenth lesson focuses on blending words with the letter “o”, a fourteenth lesson focuses on blending words with the letter “u”, a fifteenth lesson focuses on blending words with mixed vowels.

It is presently preferred that such combination teaching and learning kit 10 further includes a plurality of label members 46 each of which includes predetermined indicia 18 disposed thereon at a predetermined location for describing a corresponding picture on each of such card members 16. For example, a particular card member might include the letter “a” and a picture of an apple. On the corresponding label member, the word “apple” may be depicted.

It is presently preferred that such combination teaching and learning kit 10 further includes a predetermined phonics related song disposed at least one of on and within a fixed media 44.

It is presently preferred that such predetermined phonics related song includes the following language: “a” as in apple, “b” as in ball, “c” as in cat, “d” as in duck, “e” as in elephant, “f” as in fish, “g” as in goat, “h” as in horse, “i” as in insect, “k” as in kangaroo, “l” as in lizard, “m” as in mop, “n” as in nest, “o” as in ostrich, “p” as in pig, “q” as in quilt, “r” as in ring, “s” as in sun, “t” as in ten, “u” as in umbrella, “v” as in van, “w” as in wagon, “x” as in xray, “y” as in yarn, and “z” as in zebra.

It is presently preferred that such combination teaching and learning kit 10 further includes a predetermined number of additional card members 17 having predetermined indicia 18 thereon. It is further presently preferred that such predetermined indicia 18 includes at least one letter of a predetermined alphabet.

According to another embodiment, a method of teaching an individual to at least one of read, write, and spell is provided. Such method includes providing a chart member for at least one of free standing and attachment to a wall, a table, and an item of furniture.

Providing a plurality of card members each having at least one of a predetermined letter of a predetermined alphabet and a predetermined picture disposed on at least a first predetermined side thereof and a securing means disposed on at least a second predetermined side thereof for releasably attaching such card members to such chart member.

Instructing such individual to trace a predetermined object over a predetermined portion of a predetermined card member.

Instructing such individual to repeat a predetermined sound while at least one of viewing such predetermined card member and tracing over such predetermined portion of such predetermined card member.

It is presently preferred that such method further includes providing a tracing worksheet having predetermined indicia depicted thereon and instructing such individual to trace a predetermined item over the indicia such that at least one of a predetermined alphabet letter, symbol, picture, and a combination thereof is revealed.

It is further presently preferred that such method includes providing a bingo game relating to phonics, instructing such individual on how to play the bingo game, and playing such bingo game with at least such individual.

It is presently preferred that such method further includes providing a predetermined song relating to phonics and instructing such individual to try to sing such predetermined song at least one of along with an instructor and following along with a rendition of such song as produced from a predetermined fixed media.

It is presently preferred that such method further includes instructing such individual to arrange a plurality of such card members to spell a predetermined word.

It is presently preferred that such method further includes dividing such method into at least fifteen lessons.

It is presently preferred that such method includes teaching a first lesson focusing on the letters “m”, “a”, “s”, and “t”, a second lesson focusing on the letters “c”, “r”, “i”, and “b”, a third lesson focusing on the letters “p”, “e”, “n”, and “d”, a fourth lesson focusing on the letters “g”, “o”, “l”, and “f”, a fifth lesson focusing on the letters “a”, “e”, “i”, “o” and “u”, a sixth lesson focusing on the letters “b”, “d”, “p” and “q”, a seventh lesson focusing on the letters “a”, “c”, “d”, “e”, “g”, “o”, and “q”, an eighth lesson focusing on the letters “b”, “f”, “h”, “k”, “l”, and “t”, a ninth lesson focusing on the letters “g”, “j”, “p”, “q”, “y”, “v”, “w”, “x”, and “z”, a tenth lesson focusing on blending words with the letter “a”, an eleventh lesson focusing on blending words with the letter “i”, a twelfth lesson focusing on blending words with the letter “e”, a thirteenth lesson focusing on blending words with the letter “o”, a fourteenth lesson focusing on blending words with the letter “u”, a fifteenth lesson focusing on blending words with mixed vowels.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A combination teaching and learning kit comprising;
a. a chart member for at least one of free standing and attachment to a wall, a table, and an item of furniture;
b. a plurality of card members having predetermined indicia disposed on at least a first predetermined side thereof; and
c. a securing means disposed on at least an opposite second predetermined side thereof for releasably attaching said card members to said chart member.

2. A combination teaching and learning kit according to claim 1 wherein said securing means is shaped in a form of said predetermined indicia and is disposed on each of said first predetermined side and an opposite second predetermined side of said card members.

3. A combination teaching and learning kit according to claim 2 wherein said securing means is a hook and loop type securing means and wherein said hook and loop type securing means has a first portion thereof disposed on at least one predetermined side of said card members and wherein a second portion of said hook and loop type securing means is disposed on a predetermined location of said chart member such that said first portion and said second portion may be joined thereby releasably securing said card members to said chart member.

4. A combination teaching and learning kit according to claim 1 wherein said combination teaching and learning kit further includes a phonics bingo game.

5. A combination teaching and learning kit according to claim 1 wherein said combination teaching and learning kit further includes tracing worksheets having predetermined indicia depicted thereon such that a user may trace over said indicia to reveal at least one of a predetermined alphabet letter, symbol, picture, and a combination thereof.

6. A combination teaching and learning kit according to claim 1 wherein said combination teaching and learning kit further includes predetermined teaching instructions disposed at least one of on and within a predetermined fixed media.

7. A combination teaching and learning kit according to claim 6 wherein said fixed media is at least one of a computer processing unit, a CD, a book, a booklet, a pamphlet, a DVD, an audio cassette, and a video cassette.

8. A combination teaching and learning kit according to claim 1 wherein said indicia includes at least one predetermined letter of a predetermined alphabet and a predetermined picture of at least one of a person, an animal, and a thing being describable by a word which is spelled having a first letter substantially identical to said predetermined letter.

9. A combination teaching and learning kit according to claim 8 wherein said combination teaching and learning kit further includes a plurality of label members each of which includes predetermined indicia disposed thereon at predetermined location for describing a corresponding picture on each of said card members.

10. A combination teaching and learning kit according to claim 1 wherein said combination teaching and learning kit includes a predetermined phonics related song disposed at least one of on and within a predetermined fixed media.

11. A combination teaching and learning apparatus according to claim 1 wherein said combination teaching and learning kit further includes a predetermined number of additional card members having predetermined indicia thereon.

12. A combination teaching and learning kit according to claim 11 wherein said predetermined indicia includes at least one letter of a predetermined alphabet.

13. A combination teaching and learning kit according to claim 1 wherein said card members are laminated.

14. A combination teaching and learning apparatus according to claim 1 wherein said chart member is foldable such that said chart member may be folded at least in half.

15. A combination teaching and learning kit according to claim 8 wherein said alphabet letters are color coded according to whether said letters are consonants or vowels.

16. A method of teaching an individual to at least one of read, write, and spell including the steps of:
a. providing a chart member for at least one of free standing and attachment to a wall, a table, and an item of furniture;
b. providing a plurality of card members each having at least one of a predetermined letter of a predetermined alphabet and a predetermined picture disposed on at least a first predetermined side thereof and a securing means disposed on at least a second predetermined side thereof for releasably attaching said card members to said chart member;
c. instructing such individual to trace a predetermined object over a predetermined portion of a predetermined card member; and
d. instructing such individual to repeat a predetermined sound while at least one of viewing said predetermined card member and tracing over said predetermined portion of said predetermined card member.

17. A method of teaching an individual to at least one of read, write, and spell according to claim 16 wherein said method further includes the steps of:
a. providing a tracing worksheet having predetermined indicia depicted thereon; and
b. instructing such individual to trace a predetermined item over said indicia such that at least one of a predetermined alphabet letter, symbol, picture, and a combination thereof is revealed.

18. A method of teaching an individual to at least one of read, write, and spell according to claim 16 wherein said method further includes the steps of:
a. providing a bingo game relating to phonics;
b. instructing said individual on how to play said bingo game; and
c. playing said bingo game with at least such individual.

19. A method of teaching an individual to at least one of read, write, and spell according to claim 16 wherein said method further includes instructing such individual to arrange a plurality of said card members to spell a predetermined word.
